(19) United States
(12) Patent Application Publication
(10) Pub. No.: US 2021/0216837 A1
(43) Pub. Date: Jul. 15, 2021

(54) MEASURING INSTRUMENT AND MEASURE

(71) Applicant: FUJITSU COMPONENT LIMITED, Tokyo (JP)

(72) Inventor: Kazuya YOSHIMATSU, Tokyo (JP)

(73) Assignee: FUJITSU COMPONENT LIMITED, Tokyo (JP)

(21) Appl. No.: 17/141,912

(22) Filed: Jan. 5, 2021

(30) Foreign Application Priority Data
Jan. 9, 2020 (JP) 2020-002153

(51) Int. Cl. G06K 19/06; G01D 5/347; G06K 7/14

(52) U.S. Cl. CPC G06K 19/06018; G06K 7/1404; G01D 5/34715

(57) ABSTRACT

In a measuring instrument that measures a length using a measure, the measure including a plurality of row patterns arranged in a length direction, each of the row patterns having a plurality of patterns arranged in a width direction, one of binary values being assigned to each of the plurality of patterns, the measuring instrument includes a first reader configured to read a first row pattern, a second reader configured to read a second row pattern away from the first row pattern by a predetermined row, and a generator configured to generate a code that is a multi-digit pattern obtained by adding the second row pattern read by the second reader to the first row pattern read by the first reader.

### CROSS-REFERENCE TO RELATED APPLICATION

This application is based upon and claims the benefit of priority of the prior Japanese Patent Application No. 2020-002153 filed on Jan. 9, 2020, the entire contents of which are incorporated herein by reference.

### FIELD

A certain aspect of the embodiments is related to a measuring instrument and a measure.

### BACKGROUND

There is known a measuring instrument that measures a length of an object by optically reading a color pattern provided on a measure (e.g. Patent Document 1: Japanese Laid-open Patent Publication No. 2019-95231). This measuring instrument does not need to manually input measurement data to a terminal, and can automatically input the measurement data to the terminal.

### SUMMARY

According to an aspect of the present invention, there is provided a measuring instrument that measures a length using a measure, the measure including a plurality of row patterns arranged in a length direction, each of the row patterns having a plurality of patterns arranged in a width direction, one of binary values being assigned to each of the plurality of patterns, the measuring instrument including: a first reader configured to read a first row pattern; a second reader configured to read a second row pattern away from the first row pattern by a predetermined row; and a generator configured to generate a code that is a multi-digit pattern obtained by adding the second row pattern read by the second reader to the first row pattern read by the first reader.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram of a length measuring instrument according to a first embodiment;

FIG. 2A is a diagram illustrating an example of patterns printed on a back surface of a measure;

FIG. 2B is a diagram illustrating an arrangement of reading sensors reading patterns;

FIG. 3A is a diagram illustrating an example in which the reading sensors read patterns in an M-th row and an (M−7)-th row;

FIG. 3B is a diagram illustrating an example in which the reading sensors read patterns in the M-th row and an (M+1)-th row, and patterns in the (M−7)-th row and an (M−6)-th row;

FIG. 4A is a diagram illustrating a state in which patterns in second to sixth columns of the M-th row overlap with the reading sensors (an area 23);

FIG. 4B is a diagram illustrating a state in which the measure is shifted upward by 0.5 mm from the state illustrated in FIG. 4A;

FIG. 5 is a diagram showing a state in which the measure is shifted downward by 0.5 mm from the state illustrated in FIG. 4A;

FIG. 6 is a diagram illustrating reading sensors and patterns in a first column;

FIG. 7 is a diagram illustrating the reading sensors and the patterns in the first column;

FIG. 8A is a diagram illustrating a ratio of black read by each reading sensor in states “0/5” to “4/5” in the case of series 1 and series 2;

FIG. 8B is a diagram illustrating a total value of the ratios of black read by the reading sensors; and

FIG. 9 is a flowchart illustrating a process to be executed by the measuring instrument.

### DESCRIPTION OF EMBODIMENTS

The measuring instrument in the Patent Document 1 measures the length of the object by using the measure printed with three-color patterns to which ternary codes are assigned, respectively. When a sensor having low performance for reading differences between three or more colors is used in this measuring instrument, the patterns may not be read accurately. Further, when an error that the patterns cannot be read accurately occurs, an incorrect measurement value may be calculated, resulting in a large measurement error.

In contrast, it is also conceivable to use a sensor capable of reading two colors to read a measure on which patterns to which a binary code is assigned are printed. In this case, as the measurement value becomes longer, the patterns to which the binary code is assigned needs to have more digits than the patterns to which the ternary code is assigned, which may cause a width of the measure to become wider.

It is an object of the present disclosure to provide a measuring instrument, a measure and a measuring method that can accurately read patterns even by using a low-performance reader without increasing the number of digits in the patterns.

Hereinafter, a description will be given of the present embodiment of the present invention with reference to the drawings.

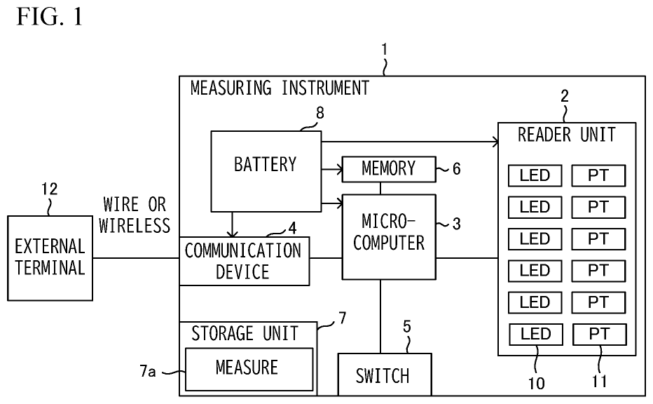

FIG. 1 is a configuration diagram of a length measuring instrument according to the present embodiment.

A length measuring instrument (hereinafter referred to as “a measuring instrument”) 1 includes: a reader unit 2 that reads a pattern from a measure 7a with multi-digit patterns; a microcomputer 3 as a calculator that calculates a length of a measurement object from data read by the reader unit 2; a communication device 4 that transmits data on the calculated length of the measurement object to an external terminal 12 by wire or wireless; a switch 5 that instructs the start of the measurement to the microcomputer 3; a memory 6 as a storage that stores information indicating a correspondence relationship between length data and a multi-digit pattern; a storage unit 7 that stores the measure 7a; and a battery 8 that supplies an electric power to the reader unit 2, the microcomputer 3, the communication device 4 and the memory 6.

The reader unit 2 includes a plurality of LEDs (Light Emitting Diode) 10 and a plurality of phototransistors (PT) 11. The LED 10 irradiates the pattern with light, and the PT 11 receive the reflected light from the pattern and converts it into a current or voltage having a value according to an amount of the received light. The LED 10 irradiates at least one of infrared light, visible light and ultraviolet light. The PT 11 receives at least one of the infrared light, the visible light and the ultraviolet light reflected by the pattern. A set of the LED 10 and the PT 11 corresponds to each of the reading sensors L1 to L20 described later.

The microcontroller 3 is a processor such as a CPU (Central Processing Unit). The microcomputer 3 controls on/off of the LED 10, and reads the current value or voltage value of the output from the PT 11. Since the reflectivities of the light are different by colors of the respective patterns, and an amount of received light of the PT 11 varies depending on the reflectivities, the microcomputer 3 is capable of determining the color of read pattern by the current value or voltage value output from the PT 1.

Further, the microcomputer 3 calculates the length of the measurement object by collating the color of the read pattern with the information indicating the correspondence relationship between the length and the pattern, which is stored in the memory 6. The information indicating the correspondence relationship between the length and the pattern is, for example, a table in which the length is associated with the combination of the colors of the patterns. Although the information indicating the correspondence relationship between the length and the pattern is stored in the memory 6, it may be stored in the external terminal 12 and the microcomputer 3 may read it from the external terminal 12 as needed.

Scales are printed on a front surface of the measure 7a along a length direction, and binary codes composed of patterns each having any one of two colors are printed on a back surface of the measure 7a at regular length intervals. Each color corresponds to one of binary values. When the reading sensor used in the reader unit has low performance to read differences between three or more colors, such as an inexpensive reading sensor, it may not be able to accurately read the patterns painted with three or more colors. In contrast, a sensor capable of reading three or more colors is relatively expensive. Therefore, in the present embodiment, patterns each having any one of two colors are used so that even the inexpensive reading sensor can read the difference in colors. In the present embodiment, two types of patterns of white and black are printed on the measure 7a.

The color of the pattern is not limited to white and black. As long as the two types of patterns can be distinguished at the time of reading, two types of patterns having the combination of other colors, two types of patterns having different densities or different brightness in the same hue, two types of patterns having different reflectivities or the like may be used. Here, the above different densities, the above different brightness and the above different reflectivities are also treated as “different colors” for convenience.

The storage unit 7 is attached to a housing of the measuring instrument 1, and is detachable from the housing of the measuring instrument 1.

The external terminal 12 is a communication terminal having a wired or wireless communication function such as a computer or a smart phone, and receives and manages data on the length of the measurement object from a communication device 4.

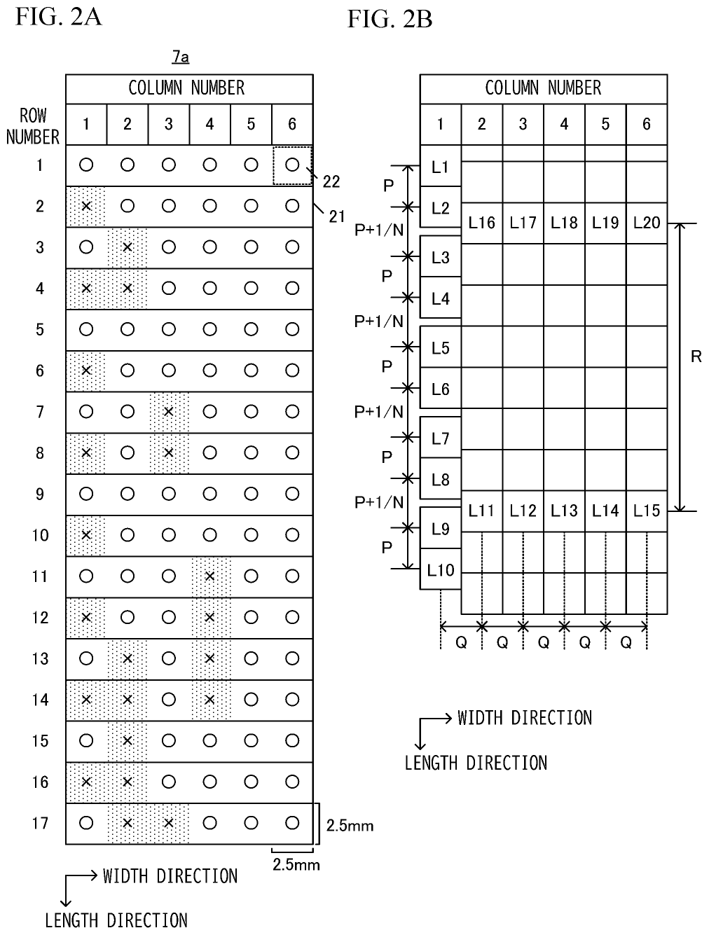

FIG. 2A is a diagram illustrating an example of patterns printed on the back surface of the measure 7a. The measure 7a includes a plurality of row patterns 21 along its length direction. A single row pattern 21 includes six individual patterns 22 along a width direction of the measure 7a. That is, the patterns 22 in six columns constitutes the single row pattern 21. FIG. 2A illustrates row patterns 21 with a total of 17 rows.

The measure according to the present embodiment expresses a length by binary values. Therefore, if it tries to increase the length that can be measured by the measure, the number of digits required to express a single length may increase, and if it tries to print the required number of digits on a single row, the width of the measure may increase. In contrast, the width of the measure can be reduced by reducing the width of the pattern, but it is necessary to increase the width of the pattern to some extent because one sensor may read adjacent patterns at the same time.

Due to such a problem, the present embodiment uses two row patterns to indicate a single measurement value. In this case, the number of digits of the patterns printed on the single row can be kept small, and the width of the measure can be prevented from increasing.

In FIG. 2A, “o” indicates white and “x” indicates black, but marks such as “o” and “x” are not described in an actual pattern. The reflectivity of white is higher than that of black. Further, the voltage value output from the PT 11 is analog data. For example, when the patterns of white and black are read, the voltage values output from the PTs 11 are 2.0 V and 1.0 V, respectively.

A length of the pattern 22 along the length direction of the measure 7a is 2.5 mm, for example, and a width of the pattern 22 along the width direction of the measure 7a is 2.5 mm, for example. That is, the pattern 22 has a 2.5 mm×2.5 mm square. However, the size of the pattern 22 is not limited to this example. Further, the length of the pattern 22 serves as a reference for a minimum length that can be measured by the measure 7a.

FIG. 2B is a diagram illustrating an arrangement of the reading sensors reading the patterns.

A set of LED 10 and PT11 constitutes a single reading sensor, and the single reading sensor is assigned to read the single pattern. In FIG. 2B, each of L1 to L20 indicates the reading sensor.

The reading sensors L11 to L15 as first readers are linearly arranged in second to sixth columns along the width direction of the measure 7a. The reading sensors L16 to L20 as second readers are linearly arranged in the second to sixth columns along the width direction of the measure 7a, and are arranged at positions separated from the reading sensors L11 to L15 by predetermined rows, i.e., 7 rows in the illustrated example, in the length direction of the measure 7a.

In this way, a reason why the reading sensors L11 to L15 and the reading sensors L16 to L20 are arranged in two rows is that the number of patterns 22 printed in the width direction of the measure 7a, that is, the number of digits can be suppressed by expressing the single measurement value with two row patterns as described above.

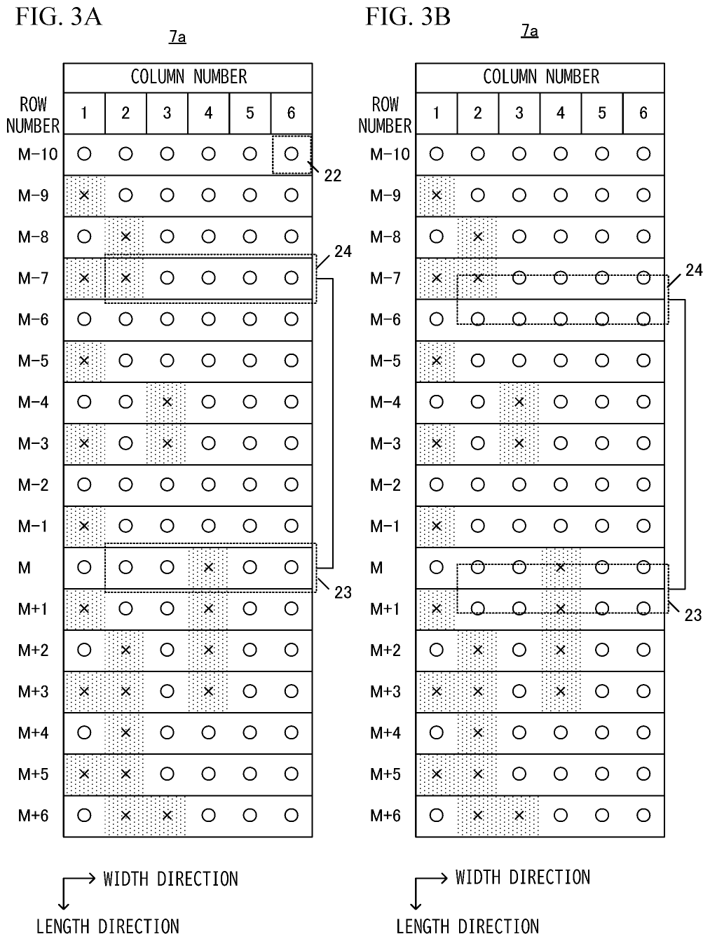

In the example of FIGS. 3A and 3B, the length is expressed as a 10-digit binary code which is a combination of 5 digits read by the reading sensors L11 to L15 and 5 digits read by the reading sensors L16 to L20. Compared with the case of printing the 10-digit code on the single row, the width of the measure 7a can be reduced. Hereinafter, the 10-digit pattern is also referred to as a “code”.

A distance R between a sensor center of the reading sensors L16 to L20 and a sensor center of the reading sensors L11 to L15 can be any value. In the example of FIG. 2B, the distance R is the length of the row patterns 21 for 7 rows, but is not necessarily limited to the length for 7 rows. A distance Q in a row direction between the centers of the reading sensors arranged in the rows adjacent to each other is 2.5 mm corresponding to the width of the pattern 22. The width of each of the reading sensors L1 to L20 may be equal to or less than the width of the pattern 22, for example, 2.5 mm or less.

When the length of a minimum unit that can be measured by the measuring instrument 1, that is, the resolution of the measuring instrument 1 is set to 1/N (N=natural number) of the length of the single pattern 22, 2×N reading sensors are linearly arranged along the length direction of the measure 7a. Since the resolution of the measuring instrument 1 is set to ⅕ of the length of the single pattern 22, i.e., 0.5 mm in FIG. 2B, N is 5 and the number of reading sensors is 10 (=2×5). In the example of FIG. 2B, the reading sensors L1 to L10 as third readers are linearly arranged in a first column along the length direction of the measure 7a. The number of reading sensors arranged in the first column is not limited to 10, and is appropriately changed according to the resolution of the measuring instrument 1. For example, when the resolution of the measuring instrument 1 is set to ½ of the length of the single pattern, N is 2 and the number of reading sensors arranged in the first column is 4 (=2×2). The reading sensors L1 to L10 should be arranged in the same column as the column in which the white and black patterns are alternately arranged in the length direction as illustrated in the first column of FIG. 2A, and do not necessarily have to be arranged in the first column.

Each of distances P between the sensor centers of the reading sensors L1 and L2, between the sensor centers of L3 and L4, between the sensor centers of L5 and L6, between the sensor centers of L7 and L8, and between the sensor centers of L9 and L10 is the same as the length of the pattern 22, for example, 2.5 mm.

Each of distances between the centers of the reading sensors L2 and L3, between the centers of L4 and L5, between the centers of L6 and L7, and between the centers of L8 and L9 is P+1/N, which is longer than the length of the pattern 22 by 1/N, for example, 3 mm (=2.5 mm+0.5 mm). A reason for setting the distance between the above sensors to P+1/N is to allow measurement of the length shorter than the length of the single pattern 22. For example, when the reading sensors L11 to L15 simultaneously read the row patterns 21 on 99th and 100th rows, a reading sensor separated from the reading sensors L11 to L15 by P+1/N is used in order to accurately measure an amount of deviation of the reading sensors L11 to L15 from the row pattern 21 on the 100th row in the length direction of the measure 7a.

FIG. 3A is a diagram illustrating an example in which the reading sensors L11 to L15 read the pattern in M-th row and the reading sensors L16 to L20 read the pattern in an (M−7)-th row. The pattern on the M-th row is any row pattern 21. The area 23 indicates the positions of the reading sensors L11 to L15, and an area 24 indicates the positions of the reading sensors L16 to L20.

The following rules apply to the patterns 22 printed on the measure 7a. (1) In the first column, the white pattern and the black pattern are alternately arranged along the length direction of the measure 7a. (2) A Hamming distance between the 10-digit pattern obtained by adding, to the patterns 22 in second to sixth columns of the M-th row, the patterns 22 in second to sixth columns of a (M−X)-th row which are away by predetermined X rows (corresponding to R in FIG. 2B; X=7 in the example of FIGS. 3A and 3B), and the 10-digit pattern obtained by adding the patterns 22 in the second to sixth columns of a (M−1)-th row and a (M−(X+1))-th row adjacent to the above patterns 22 or the 10-digit pattern obtained by adding the patterns 22 in the second to sixth columns of a (M+1)-th row and a (M−(X−1))-th row adjacent to the above patterns 22 is “1”. That is, the 10-digit pattern obtained by adding the patterns 22 in the second to sixth columns of the M-th row to the patterns 22 in the second to sixth columns of the (M−X)-th row is different in the black and white of the pattern by only one digit from the 10-digit patterns in two rows adjacent to the M-th row and the (M−X)-th row. (3) The 10-digit pattern obtained by adding the patterns 22 in the second to sixth columns of the (M−X)-th row to the patterns 22 in the second to sixth columns of the M-th row is only one of all the 10-digit patterns.

When the reading sensors L11 to L15 read the patterns 22 in the second to sixth columns of the M-th row in FIG. 3A, the reading sensors L16 to L20 read the patterns 22 in the second to sixth columns of a (M−7)-th row. In the present embodiment, a total of 10-digit patterns read by the reading sensors L11 to L15 and the reading sensors L16 to L20 are regarded as a single code. At the time of measuring the length, the length corresponding to the patterns 22 in the second to sixth columns of the M-th row read by the reading sensors L11 to L15 is the length to be measured. When the reading values in the second to sixth columns of the M-th row and the reading values in the second to sixth columns of the (M−7)-th row are arranged in this order, the reading values of the reading sensors L11 to L15 and L16 to L20 are “ooxoox0000”, and the length is expressed by a 10-bit binary code.

Similarly, when the reading sensors L11 to L15 read the patterns 22 in the second to sixth columns of the (M+1)-th row, the reading sensors L16 to L20 read the patterns 22 in the second to sixth columns of the (M−6)-th row. In this case, since the reading values are “oox0000000”, only the reading value of the reading sensor L16 changes from “x” to “o”, compared with the reading values in the second to sixth columns of the M-th row and the (M−7)-th row. When the reading sensors L11 to L15 read the patterns 22 in the second to sixth columns of the (M−1)-th row, the reading sensors L16 to L20 read the patterns 22 in the second to sixth columns of the (M−8)-th row. In this case, since the reading values are “00000x0000”, only the reading value of the reading sensor L13 changes from “x” to “o”, compared with the reading values in the second to sixth columns of the M-th row and the (M−7)-th row. Thus, the Hamming distance between the 10-digit pattern read by the reading sensors L11 to L20 and the 10-digit pattern adjacent thereto is “1”.

FIG. 3B is a diagram illustrating an example in which the reading sensors L11 to L15 read the patterns in M-th row and the (M+1)-th row and the reading sensors L16 to L20 read the patterns in the (M−7)-th row and the (M−6)-th row. The positions of the areas 23 and 24 in FIG. 3B are different from those in FIG. 3A.

In FIG. 3B, the reading sensors L11 to L15 are arranged so as to overlap the boundaries of the patterns 22 in the second to sixth columns of the M-th row and the (M+1)-th row, and the reading sensors L16 to L20 are arranged so as to overlap the boundaries of the patterns 22 in the second to sixth columns of the (M−7)-th row and the (M−6)-th row. In this case, the reading sensor L16 is affected by both of “x” (black) and “o” (white), and indicates a value larger than 1.0 V and smaller than 2.0 V, which is neither “x” nor “o”. However, regardless of which reading value is indicated by the reading sensor L16, the patterns in the second to sixth columns of the M-th row and the patterns in the second to sixth columns of the (M+1)-th row are the same as each other, and the patterns in the third to sixth columns of the (M−7)-th row and the patterns in the third to sixth columns of the (M−6)-th row are the same as each other, according to the above pattern rule (2). Therefore, the output values of the reading sensors L11 to L15 and L17 to L20 indicate accurate reading values corresponding to the patterns being read. Therefore, considering the above pattern rule (3), the microcomputer 3 calls information on the patterns 22 in each row stored in the memory 6 in advance, and collates this information with the reading values of the reading sensors L11 to L20. This can determine that the reading sensors L11 to L15 read at least one of the patterns 22 in the second to sixth columns of the M-th row and the patterns 22 in the second to sixth columns of the (M+1)-th row, and the reading sensors L16 to L20 read at least one of the patterns 22 in the second to sixth columns of the (M−7)-th row and the patterns 22 in the second to sixth columns of the (M−6)-th row.

Since the reading sensors L11-L15 and L16-L20 are arranged in the two rows in this way, the number of digits of the patterns printed in the width direction of the measure 7a can be suppressed. Since the Hamming distance between the 10-digit pattern read by the reading sensors L11 to L20 and the 10-digit pattern adjacent thereto is “1”, the microcomputer 3 can determine, based on the values of the reading sensors L11 to L20, that the reading sensors L11 to L15 read both or one of the patterns 22 in the second to sixth columns of the M-th row and the patterns 22 in the second to sixth columns of the (M+1)-th row, and the reading sensors L16 to L20 read both or one of the patterns 22 in the second to sixth columns of the (M−7)-th row and the patterns 22 in the second to sixth columns of the (M−6)-th row.

Next, a description is given of a method of determining an amount by which the reading sensors L11 to L15 are shifted upward or downward relative to the row pattern of the M-th row based on a state where the patterns 22 in the second to sixth columns of the M-th row overlaps the reading sensors L11 to L15 (area 23), by using the reading sensors L1 to L10 that read the patterns in the first column.

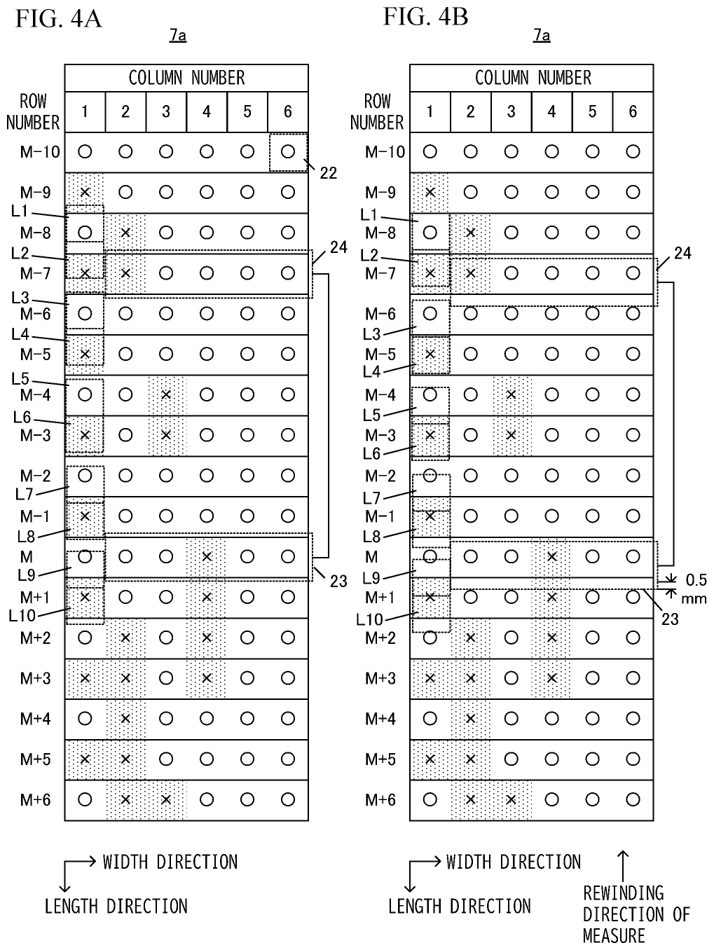

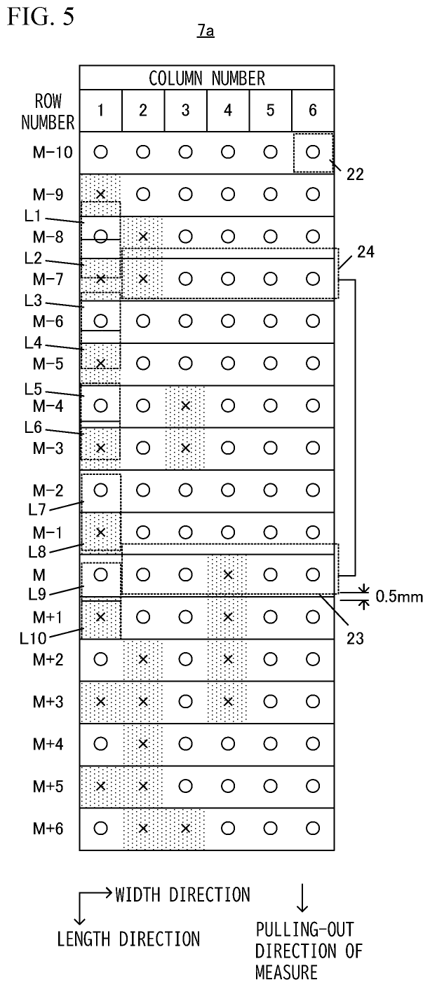

FIG. 4A is a diagram illustrating a state in which the patterns 22 in the M-th row overlap with the area 23. FIG. 4B is a diagram illustrating a state in which the measure 7a is shifted upward by 0.5 mm from the state of FIG. 4A. FIG. 5 is a diagram illustrating a state in which the measure 7a is shifted downward by 0.5 mm from the state of FIG. 4A. When the measure 7a is rewound, the measure 7a shifts to an upper side of FIG. 4A, and the measurement length decreases. When the measure 7a is pulled out, the measure 7a shifts to a lower side of FIG. 4A, and the measurement length increases. The positions of the reading sensors L1 to L10 are indicated by dotted lines on the patterns in the first column of FIGS. 4A, 4B and 5B. Hereinafter, a state in which the measure 7a shifts in the direction of being pulled out from a reference state is referred to as a series 1, and a state in which the measure 7a shifts in the direction of being rewound from the reference state is referred to as a series 2.

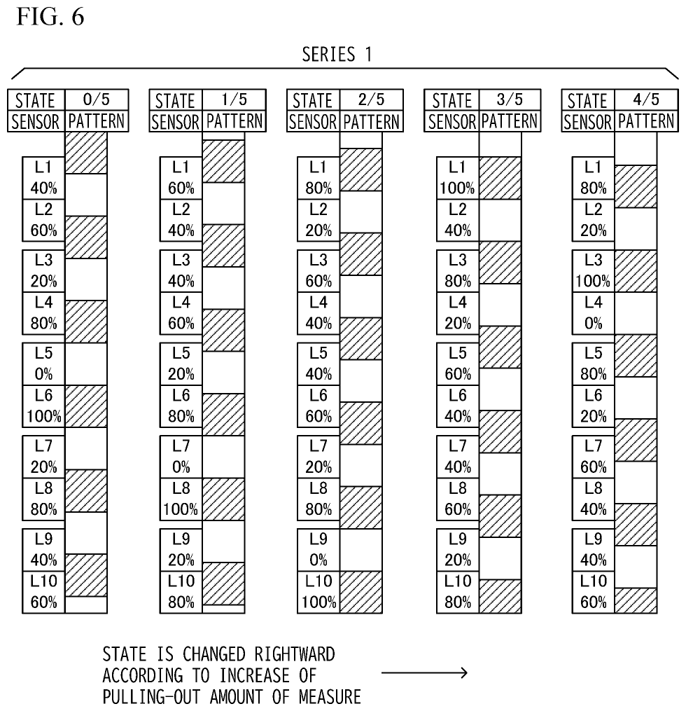

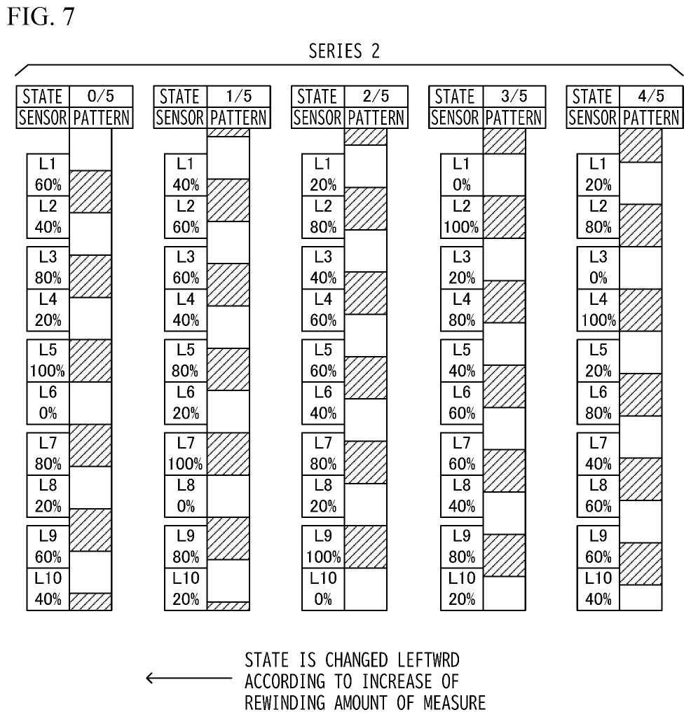

FIGS. 6 and 7 are diagrams illustrating the states of the reading sensors L1 to L10 and the patterns 22 in the first column,

As described above, the patterns of white and black are alternately arranged in the first column of the measure 7a along the length direction of the measure 7a. In FIGS. 6 and 7, a percent illustrated below a sensor number indicates a ratio of the amount of light received by each sensor when the amount of light received at the time of reading the black pattern is 100%, which corresponds to the ratio of black read by each reading sensor. For example, the “40%” indicates that the reading sensor reads 40% of the black pattern and 60% of the white pattern. The “100%” indicates that the reading sensor reads only the black pattern. The “0%” indicates that the reading sensor reads only the white pattern.

A state “0/5” in FIG. 6 indicates the ration of black read by the reading sensors L1 to L10 when the patterns 22 in the second to sixth columns of the M-th row overlaps the area 23 as illustrated in FIG. 4A. The series 1 in FIG. 6 indicate the ratio of black read by the reading sensors L1-L10 when the measure 7a is pulled out by 0.5 mm corresponding to the resolution of the measuring instrument 1 from the state “0/5”, that is, when the measure 7a is shifted by 0.5 mm to the lower side of FIG. 4A. In the series 1, each time the measure 7a is pulled out by 0.5 mm, the ratio of black read by the reading sensors L1 to L10 changes in an order of the state “0/5”, the state “1/5”, the state “2/5”, the state “3/5” and the state “4/5” in FIG. 6. The state “1/5” in FIG. 6 indicates a state in which the reading sensors L1 to L10 in FIG. 5 read the patters 22.

In contrast, the series 2 in FIG. 7 indicate the ratio of black read by the reading sensors L1-L10 when the measure 7a is rewound by 0.5 mm from the state “0/5”, that is, when the measure 7a is shifted by 0.5 mm to the upper side of FIG. 4A. In the series 2, each time the measure 7a is rewound by 0.5 mm, the ratio of black read by the reading sensors L1 to L10 changes in an order of the state “0/5” in FIG. 6, the state “4/5” in FIG. 7, the state “3/5” in FIG. 7, the state “2/5” in FIG. 7 and the state “1/5” in FIG. 7. The state “4/5” in FIG. 7 indicates a state in which the reading sensors L1 to L10 in FIG. 4B read the patters 22.

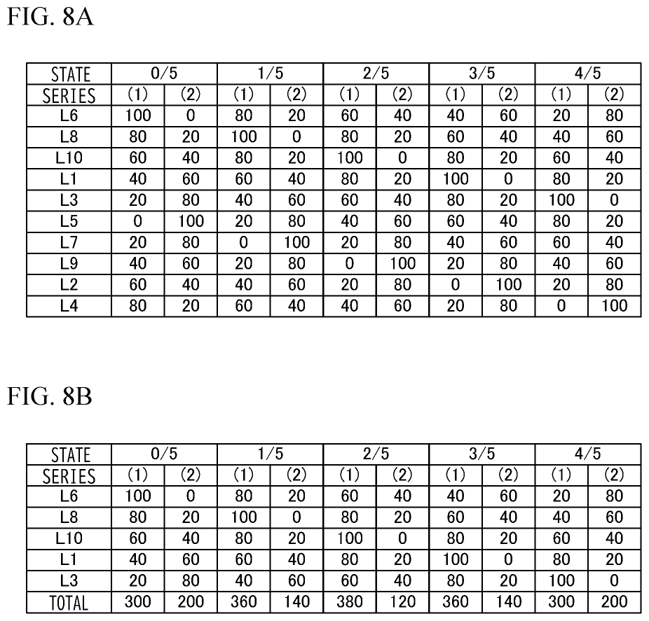

FIG. 8A is a diagram illustrating the ratio of black read by each reading sensor in the states “0/5” to “4/5” in the case of the series 1 and the series 2. FIG. 8B is a diagram illustrating a total value of the ratios of black read by the reading sensors L1, L3, L6, L8 and L10.

As illustrated in FIG. 8B, the total value of the ratios of black read by the reading sensors L1, L3, L6, L8 and L10 is 300% or more in the series 1 and 200% or less in the series 2. Therefore, the series 1 and the series 2 can be distinguished from each other by, for example, 250% as a threshold value.

As can be seen from FIG. 8A, the total value of the ratios of black read by the reading sensors L2, L4, L5, L7 and L9 is 200% or less in the series 1 and 300% or more in the series 2. Therefore, the series 1 and the series 2 may be distinguished by using the total value of the ratios of black read by the reading sensors L2, L4, L5, L7 and L9, instead of the reading sensors L1, L3, L6, L8 and L10.

The microcomputer 3 determines whether the total value of the ratios of black read by the reading sensors L1, L3, L6, L8 and L10 corresponds to the series 1 or the series 2, by using the threshold value. When the total value of the ratios of black corresponds to the series 1, the measure 7a is pulled out from the state where the patterns 22 in the second to sixth columns of the M-th row overlap the reading sensors L11 to L15. Therefore, the microcomputer 3 determines that the reading sensors L11 to L15 read the patterns 22 in the second to sixth columns of the M-th row and the (M−1)-th row, for example, as illustrated in FIG. 5. When the total value of the ratios of black corresponds to the series 2, the measure 7a is rewound from the state where the patterns 22 in the second to sixth columns of the M-th row overlap the reading sensors L11 to L15. Therefore, the microcomputer 3 determines that the reading sensors L11 to L15 read the patterns 22 in the second to sixth columns of the M-th row and the (M+1)-th row, for example, as illustrated in FIG. 4B. That is, the microcomputer 3 determines whether the reading sensors L11 to L15 are shifted toward the (M−1)-th row side or the (M+1)-th row side of the measure 7a with reference to the patterns 22 in the second to sixth columns of the M-th row, based on whether the total value of the ratios of black read by the reading sensors L1, L3, L6, L8 and L10 corresponds to the series 1 or the series 2.

Next, in the case of the series 1, the microcomputer 3 specifies the reading sensor at a position where the ratio of black is 100% from the values read by the reading sensors L1, L3, L6, L8 and L10, and determines which of the states “0/5” to “4/5” the current state is, that is, determines the amount by which the reading sensors L11 to L15 are shifted toward the (M−1)-th row side from the row pattern in the M-th row. When the current state is the state “1/5” in the series 1, the microcomputer 3 can determine that the reading sensors L11 to L15 are shifted by 0.5 mm toward the (M−1)-th row side from the row pattern in the M-th row. In this case, the measurement value is a length obtained by adding 0.5 mm to the length corresponding to the M-th row. When the current state is the state “2/5” in the series 1, the microcomputer 3 can determine that the reading sensors L11 to L15 are shifted by 1.0 mm toward the (M−1)-th row side from the row pattern in the M-th row.

Since the reading sensors L1, L3, L6, L8 and L10 are shifted by 0.5 mm (=1/N) with respect to a multiple of length of the single pattern, the ratio of black in any one of the reading sensors is expected to be 100% for each 0.5 mm. Therefore, the length can be measured by 0.5 mm unit corresponding to the resolution of the measuring instrument 1, as described above. In contrast, the microcomputer 3 may specify the reading sensor at a position where the ratio of black is 0% from the values read by the reading sensors L2, L4, L5, L7, and L9, and may determine which of the states “0/5” to “4/5” the current state is.

An amount of shift is not always in the 0.5 mm unit, and the ratios of black in any reading sensors may not be 100%. In such a case, the length may be calculated in the 0.5 mm unit on the basis of the reading sensor in which the ratio of black among the reading sensors L1, L3, L6, L8 and L10 is closest to 100%.

In the case of the series 2, the microcomputer 3 specifies the reading sensor at a position where the ratio of black is 0% from the values read by the reading sensors L1, L3, L6, L8 and L10, and determines which of the states “0/5” to “4/5” the current state is, that is, determines the amount by which the reading sensors L11 to L15 are shifted toward the (M+1)-th row side from the row pattern in the M-th row. When the current state is the state “4/5” in the series 2 for example, the microcomputer 3 can determine that the reading sensors L11 to L15 are shifted by 0.5 mm toward the (M+1)-th row side from the row pattern in the M-th row. In this case, the measurement value is a length obtained by subtracting 0.5 mm from the length corresponding to the M-th row. When the current state is the state “3/5” in the series 3, the microcomputer 3 can determine that the reading sensors L11 to L15 are shifted by 1.0 mm toward the (M+1)-th row side from the row pattern in the M-th row. Here, the microcomputer 3 may specify the reading sensor at a position where the ratio of black is 100% from the values read by the reading sensors L2, L4, L5, L7, and L9, and may determine which of the states “0/5” to “4/5” the current state is.

In the state “0/5”, the measure 7a is not shifted, and hence the microcomputer 3 can determine that the reading sensors L11 to L15 read only the single row pattern.

In the above, the reading sensors are divided into a group of reading sensors L1, L3, L6, L8 and L10 and a group of reading sensors L2, L4, L5, L7 and L9. This grouping is set so that the difference in the total values of the ratios of black read by the two groups of reading sensors becomes large, in order to make it easier to determine whether the current state is in the series 1 or the series 2, i.e., whether the read sensors L11 to L15 are shifted toward the (M−1)-th row side or the (M+1)-th row side of the measure 7a. When the reading sensors L1 and L2 are included in the same group, for example, the total value of the ratios of black read by the reading sensors L1 and L2 becomes 100 in any state in the series 1 and the series 2, and hence the microcomputer 3 cannot determine whether the sensors L11 to L15 are shifted toward the (M−1)-th row side or the (M+1)-th row side of the measure 7a. To avoid this, for example, the reading sensors L1 to L10 are grouped in such a way that the reading sensor indicating a value of 100 and the reading sensor indicating a value of 0 belong to different groups from each other in the same state of the same series.

When the resolution is set to 1/N of the length of the pattern, the number of reading sensors arranged in the first column may be N instead of 2×N. In the example of FIG. 8B, only five reading sensors L1, L3, L6, L8 and L10 are used to determine which of the states “0/5” to “4/5” the current state is. Therefore, even if only five reading sensors L1, L3, L6, L8, and L10 are provided in the first column, the microcomputer 3 can determine a shift direction and a shift amount of the reading sensors L11 to L15 with respect to the measure 7a. On the contrary, the shift direction and the shift amount can be determined by also providing only five reading sensors L2, L4, L5, L7, and L9 in the first column.

In FIGS. 6 to 8B, the ratio of black is used for convenience of explanation, but since the microcomputer 3 acquires the voltage values corresponding to the read color from each of the reading sensors L1 to L20, the voltage value corresponding to the ratio of black is actually used. It is assumed that information indicating the reading values (e.g., densities or voltage values) of the patterns 22 in the first column in each state where the measure 7a is shifted by ⅕ of the length of the single pattern from the reference position where the reading sensors L11 to L15 overlap with any row pattern 21 (e.g., the M-th row) is stored in the memory 6 in advance, as illustrated in FIGS. 6 to 8B.

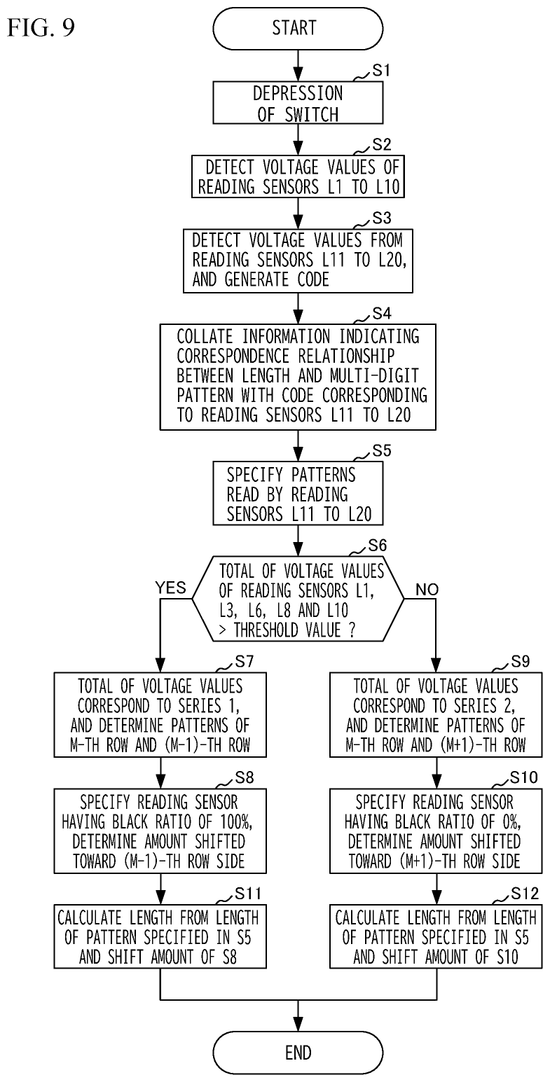

FIG. 9 is a flowchart illustrating a process to be executed by the measuring instrument 1. It is assumed that the voltage values of the patterns 22 of black and white and the threshold value for determining black and white are defined in advance. For example, a detection voltage of 1.0 V is defined as a black density of 100%, and a detection voltage of 2.0 V is defined as a black density of 0% (or a white density of 100%).

First, when the switch 5 is depressed (S1), the length measurement is started. The switch 5 is depressed at the timing of reading the patterns after the measure 7a is arranged on the measurement object. The microcomputer 3 detects the voltage values from the reading sensors L1 to L10 (S2).

Next, the microcomputer 3 detects the voltage values from the reading sensors L11 to L20 (S3). Here, in order to regard the patterns 22 for two rows read by the reading sensors L11 to L15 and the reading sensors L16 to L20 as a single code, the microcomputer 3 generates the code corresponding to the voltage values of the reading sensors L11 to L20, which are obtained by adding the voltage values from the reading sensors L16 to L20 to the voltage values from the reading sensors L11 to L15.

The microcomputer 3 calls the information indicating the correspondence relationship between the length and the multi-digit pattern stored in the memory 6 in advance, collates this information with the code corresponding to the voltage values of the reading sensors L11 to L20 (S4), and specifies the patterns read by the reading sensors L11 to L20 (S5). In the processes of S4 and S5, the row pattern 21 in one or two rows read by each set of the reading sensors L11 to L15 and the reading sensors L16 to L20 can be specified, as illustrated in FIGS. 3A and 3B. Since the actual length of the measurement object is the length corresponding to the row pattern read by the reading sensors L11 to L15, the microcomputer 3 can calculate an approximate length of the measurement object from the row pattern 21 in one or two rows read by the reading sensors L11 to L15. When the reading sensors L11 to L15 read the row pattern in the M-th row and the row pattern in the (M−1)-th row, the length can be obtained with an error up to the length of the single pattern. If the two cases of shifting to the (M−1)-th row side and shifting to the (M+1)-th row side are considered when reading the row pattern in the M-th row, the measurement value of the length when reading the row pattern in the M-th row may include an error up to the length of two patterns.

Next, the microcomputer 3 determines whether the total of the voltage values of the reading sensors L1, L3, L6, L8, and L10 is larger than the threshold value (S6). When the total of the voltage values of the reading sensors L1, L3, L6, L8, and L10 is larger than the threshold value (YES in S6), the total of the voltage values of the reading sensors L1, L3, L6, L8 and L10 corresponds to the series 1. Therefore, the microcomputer 3 determines that the reading sensors L11 to L15 read the patterns 22 in the second to sixth columns of the M-th row and the (M−1)-th row (S7).

Next, the microcomputer 3 specifies the reading sensor at the position where the ratio of black is 100% from the voltage values of the reading sensors L1, L3, L6, L8 and L10, and determines which of the states “0/5” to “4/5” in the series 1 the current state is, to determine the amount by which the reading sensors L11 to L15 are shifted toward the (M−1)-th row side from the row pattern in the M-th row (S8). As mentioned above, the state “0/5” in the series 1 indicates no shift amount. The microcomputer 3 sums the length corresponding to the row pattern in the M-th row specified in S5 and the amount shifted to the (M−1)-th row side determined in S8 to calculate the length of the measurement object (S11). This completes the present process. Here, the length corresponding to the row pattern in the M-th row specified in S5 is a length (hereinafter referred to as “a reference length”) from a start point (0 cm) to a reference position of the measure 7a. The length of the measurement object is calculated by summing the reference length and the amount shifted to the (M−1)-th row side determined in S8.

On the other hand, when the total of the voltage values of the reading sensors L1, L3, L6, L8, and L10 is equal to or smaller than the threshold value (NO in S6), the total of the voltage values of the reading sensors L1, L3, L6, L8 and L10 corresponds to the series 2. Therefore, the microcomputer 3 determines that the reading sensors L11 to L15 read the patterns 22 in the second to sixth columns of the M-th row and the (M+1)-th row (S9).

Next, the microcomputer 3 specifies the reading sensor at the position where the ratio of black is 0% from the voltage values of the reading sensors L1, L3, L6, L8 and L10, and determines which of the states “0/5” to “4/5” in the series 2 the current state is, to determine the amount by which the reading sensors L11 to L15 are shifted toward the (M+1)-th row side from the row pattern in the M-th row (S10). The microcomputer 3 sums the length corresponding to the row pattern in the M-th row specified in S5 and the amount shifted to the (M+1)-th row side determined in S10 to calculate the length of the measurement object (S12). This completes the present process. In S12, the length of the measurement object is calculated by summing the reference length from the start point (0 cm) to the reference position of the measure 7a and the amount shifted to the (M+1)-th row side determined in S10.

With the above process, the length of the measurement object can be measured with an accuracy of ⅕ of the length of the single pattern, i.e., 0.5 mm. Further, since the length of the measurement object can be measured with the accuracy shorter than the length of the single pattern, a measurement error can be reduced.

Instead of S6 in FIG. 9, the microcomputer 3 may determine which of the voltage values of the reading sensors L1, L3, L6, L8 and L10 corresponds to the voltage value when the pattern of 100% black in FIG. 8A is read. When any of the voltage values of the reading sensors L1, L3, L6, L8 and L10 corresponds to the voltage value when the pattern of 100% black is read, the current state corresponds to the series 1 with reference to FIG. 8A. Therefore, the microcomputer 3 determines that the reading sensors L11 to L15 read the patterns 22 in the second to sixth columns of the M-th row and the (M−1)-th row (S7). When none of the voltage values of the reading sensors L1, L3, L6, L8 and L10 corresponds to the voltage value when the pattern of 100% black is read, the current state corresponds to the series 2 with reference to FIG. 8A. Therefore, the microcomputer 3 determines that the reading sensors L11 to L15 read the patterns 22 in the second to sixth columns of the M-th row and the (M+1)-th row (S9).

Instead of S6 in FIG. 9, the microcomputer 3 may determine which of the voltage values of the reading sensors L1, L3, L6, L8 and L10 corresponds to the voltage value when the pattern of 0% black in FIG. 8A is read. When any of the voltage values of the reading sensors L1, L3, L6, L8 and L10 corresponds to the voltage value when the pattern of 0% black is read, the current state corresponds to the series 2 with reference to FIG. 8A. Therefore, the microcomputer 3 determines that the reading sensors L11 to L15 read the patterns 22 in the second to sixth columns of the M-th row and the (M+1)-th row (S9). When none of the voltage values of the reading sensors L1, L3, L6, L8 and L10 corresponds to the voltage value when the pattern of 0% black is read, the current state corresponds to the series 1 with reference to FIG. 8A. Therefore, the microcomputer 3 determines that the reading sensors L11 to L15 read the patterns 22 in the second to sixth columns of the M-th row and the (M−1)-th row (S7).

In the present embodiment, the reading sensors L1 to L10 are provided to measure the length with the accuracy of ⅕ of the length of the single pattern, but the number of reading sensors in the first column may be increased or decreased according to the measurement accuracy. When the length is measured with the accuracy of ½ of the length of the single pattern, the number of reading sensors arranged in the first column may be four.

When the length is measured with the accuracy of the length of the single pattern, that is, when the measurement error corresponding to the length of the single pattern is allowed, only one reading sensor may be arranged in the first column in the same manner as the second to sixth columns. Even with such an arrangement of the reading sensors, the reading sensor arranged in the first column can determine whether the single row pattern is read or the two row patterns with the boundary are read.

In S6 of FIG. 9, the total of the voltage values of the reading sensors L1, L3, L6, L8, and L10 is used, taking into account a case where there is no large difference more than a predetermined value between a voltage value when each reading sensor reads the pattern of 100% black and a voltage value when it reads the pattern of 80% black, for example. For example, when the sensitivity of each reading sensor is good and there are differences equal to or more than the predetermined value between the voltage values when the respective patterns of 0% black, 20% black, 40% black, 60% black, 80% black and 100% black are read, the number of reading sensors arranged in the first column may be two.

When the reading sensor arranged in the first column is only the reading sensor L6 for example, the microcomputer 3 cannot specify whether the current state is the state “1/5” of the series 1 or the state “4/5” of the series 2, based on the voltage value (black density) when the reading sensor L6 reads the pattern of 80% black and the information illustrated in FIG. 8A. However, when two reading sensors L6 and L8 are arranged in the first column, the voltage values (black densities) of the reading sensor L8 in the state “1/5” of the series 1 and the state “4/5” of the series 2 are different from each other, and hence the microcomputer 3 can specify the current state using the two reading sensors L6 and L8. That is, the microcomputer 3 can determine which of the states “0/5” to “4/5” in the series 1 or 2 the current state corresponds to, based on the voltage values (black densities) read by the reading sensors L6 and L8 and the information illustrated in FIG. 8A. In at least two reading sensors arranged in the first column, it is necessary that when one reading sensor has the same voltage value (black density) in the two series or the two states, the other reading sensor has a different voltage value (black density) in the same series or the same state as the one reading sensor.

Thus, the microcomputer 3 may calculate the shift amount from the reference position in the length direction of the measure 7a, based on the voltage values read by the reading sensors arranged in the first column, and the information indicating the reading values (e.g., black densities or voltage values) of the patterns 22 in the first column in each state where the measure 7a is shifted by ⅕ of the length of the single pattern from the reference position where the read sensors L11 to L15 overlap with any row pattern 21.

According to the present embodiment, one of the binary values is assigned to each pattern printed on the measure 7a, the Hamming distance between the 10-digit pattern obtained by adding the patterns 22 read by the reading sensors L16-L20 to the patterns 22 read by the reading sensors L11-L15, and another 10-digit pattern adjacent to the 10-digit pattern in the length direction is “1”, and the 10-digit pattern obtained by adding the patterns 22 read by the reading sensors L16-L20 to the patterns 22 read by the reading sensors L11-L15 corresponds to only one of all the 10-digit patterns included in the measure 7a. In the measuring instrument 1, the reading sensors L16 to L20 are arranged away from the reading sensors L11 to L15 by a predetermined row. The length is measured using the 10-digit pattern, which is regarded as the single row pattern, obtained by adding the patterns 22 read by the reading sensors L16 to L20 to the patterns 22 read by the reading sensors L11 to L15. Therefore, since the 10-digit pattern is not arranged in the single row in the width direction, but is divided into the two rows, the number of digits in the patterns 22 can be suppressed so that the patterns 22 fit into the width of the measure. Since any one of the binary values is assigned to each pattern having any one of the two colors, the pattern 22 can be read accurately even if the inexpensive sensor having low performance for reading differences of three or more colors is used as the reading sensor L11-L20.

The measure 7a includes a column pattern in which the black pattern and the white pattern are alternately arranged in the length direction. When the resolution is 1/N (N: an integer of 2 or more) of the length of the single pattern, the measuring instrument 1 further includes 2×N reading sensors L1 to L10 that read the column patterns in which the black pattern and the white pattern are alternately arranged. Then, the reading sensors L1 to L10 are arranged so as to be separated by 1/N of the length of the single pattern every two adjacent sensors along the length direction. In this case, by executing the processes of S6 to S10 in FIG. 9, the amount by which the reading sensors L11 to L15 are shifted to the (M−1)-th row side or the (M+1)-th row side from the row pattern in the M-th row can be calculated with the accuracy of 1/N of the length of the single pattern.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A measuring instrument that measures a length using a measure, the measure including a plurality of row patterns arranged in a length direction, each of the row patterns having a plurality of patterns arranged in a width direction, one of binary values being assigned to each of the plurality of patterns, the measuring instrument comprising:
a first reader configured to read a first row pattern;
a second reader configured to read a second row pattern away from the first row pattern by a predetermined row; and
a generator configured to generate a code that is a multi-digit pattern obtained by adding the second row pattern read by the second reader to the first row pattern read by the first reader.

2. The measuring instrument as claimed in claim 1, further comprising:
a third reader configured to read a column pattern included in the measure, the column pattern including patterns to which binary values are assigned, respectively, and which are arranged alternately in the length direction.

3. The measuring instrument as claimed in claim 1, further comprising:
a storage configured to store first information indicating a correspondence relationship between length data and the multi-digit pattern; and
a calculator configured to calculate the length to be measured, based on the code generated by the generator and the first information.

4. The measuring instrument as claimed in claim 2, further comprising:
a storage configured to store first information indicating a correspondence relationship between length data and the multi-digit pattern, and second information indicating a reading value of the column pattern in each state where the measure is shifted by 1/N (N: an integer of 2 or more) of a length of a single pattern from a reference position where the first reader overlap with the first row pattern; and
a calculator configured to calculate a first length from a start point of the measure to the reference position based on the code generated by the generator and the first information, calculate a shift amount of the measure in the length direction from the reference position based on a reading value of the column pattern read by the third reader and the second information, and calculate the length to be measured, based on the first length and the shift amount.

5. The measuring instrument as claimed in claim 1, wherein
a Hamming distance between the multi-digit pattern obtained by adding the second row pattern to the first row pattern, and another multi-digit pattern adjacent to the multi-digit pattern in the length direction is 1, and the multi-digit pattern corresponds to only one of all multi-digit patterns included in the measure.

6. A measuring instrument that measures a length using a measure, the measure including a plurality of row patterns arranged in a length direction, each of the row patterns having a plurality of patterns arranged in a width direction, one of binary values being assigned to each of the plurality of patterns, the measuring instrument comprising:
a first reader configured to read a first row pattern;
a second reader configured to read a second row pattern away from the first row pattern in the length direction by a predetermined row; and
a third reader configured to read a column pattern arranged in the length direction;
wherein the third reader includes 2×N (N: an integer of 2 or more) readers when a resolution is 1/N of a length of a single pattern, and the 2×N readers are arranged so as to be separated by 1/N of the length of the single pattern every two readers along the length direction.

7. A measure comprising:
a plurality of row patterns arranged in a length direction, each of the row patterns having a plurality of patterns arranged in a width direction, one of binary values is assigned to each of the plurality of patterns; and
a column pattern including patterns to which the binary values are assigned, respectively, and which are arranged alternately in the length direction;
wherein a Hamming distance between a multi-digit pattern obtained by adding a second row pattern to a first row pattern, the second row pattern being away from the first row pattern in the length direction by a predetermined row, and another multi-digit pattern adjacent to the multi-digit pattern in the length direction is 1, and
wherein the multi-digit pattern corresponds to only one of all multi-digit patterns included in the measure.
